(19) United States
(12) Patent Application Publication
(10) Pub. No.: US 2026/0205475 A1
(43) Pub. Date: Jul. 16, 2026

(54) INTELLIGENTLY SECURING ANOMALOUS DATA STREAMS

(71) Applicant: Varonis Systems, Inc., New York, NY (US)

(72) Inventors: Amit OSI, Tel Aviv-Yafo (IL); Liron RAVEH, Tel Aviv-Yafo (IL); Lior CHEN, Tel Aviv (IL)

(21) Appl. No.: 19/017,272

(22) Filed: Jan. 10, 2025

(51) Int. Cl. H04L 9/40; G06F 21/55

(52) U.S. Cl. CPC H04L 63/1425; G06F 21/554; H04L 63/1483

(57) ABSTRACT

Disclosed is a system and method for intelligently securing anomalous data streams in a computer network. One or more machine learning models are trained to identify anomalous data and to, when identified, categorize each respective identified anomalous data into one of a plurality of categories. The system monitors, in real time, data streams transmitted through the computer network, and automatically determines, by the one or more machine learning models, that a data stream transmitted through the network includes anomalous data and determines a category of the anomalous data. The system then automatically selects a data protection action for the anomalous data based on the determined category of the anomalous data, and automatically performs the data protection action.

### TECHNICAL FIELD

The present invention relates to anomaly detection in large data sets.

### BACKGROUND

Enterprise data systems and computer networks manage high volumes of critical and sensitive information. Ensuring the integrity and security of this data—and data of its users—is essential, as irregular patterns—such as unexpected data transfers, unauthorized access attempts, phishing attempts, and abnormal usage—may signal threats like security breaches, operational failures, or targeted attacks. Traditional methods of anomaly detection, typically based on predefined rules or thresholds, are often insufficient in today's rapidly evolving threat landscape, as they struggle to adapt to new forms of malicious activity, producing false positives or failing to detect genuine threats.

One area of concern in anomaly detection includes identifying phishing and malware activity, both of which are major attack vectors in enterprise environments. Phishing emails attempt to deceive users into revealing sensitive information, often leading to unauthorized access or data exfiltration, while malware can disrupt operations, compromise data integrity, or lead to unauthorized control of network resources. Effective detection systems should be capable of analyzing multiple types of data simultaneously, including network traffic, application logs, and database records, as well as provide real-time detection and adapt to changing operational conditions.

### SUMMARY

According to various aspects, the subject technology addresses the limitations of existing approaches to anomaly detection by providing an intelligent system designed to automate both detection and classification in real-time data streams. Using machine learning and language models, this system not only detects and labels anomalies but also provides reasoning for their anomalous nature. It employs a two-stage model; the first model predicts if a document is anomalous, and if so, the second model identifies the type or category of the anomaly. Furthermore, a language model is used to explain why the document is considered an anomaly. This technology significantly enhances the efficiency and effectiveness of identifying, classifying, and understanding anomalies in data streams, potentially offering improved threat detection and response times.

In particular, a machine-implemented method for protecting data streams in a computer network is disclosed. According to various aspects, the subject technology comprises training one or more machine learning models to identify anomalous data and to, when identified, categorize each respective identified anomalous data into one of a plurality of categories; monitoring, in real time, data streams transmitted through a computer network of an organization; automatically determining, in real time, based on the monitoring, that a data stream transmitted through the computer network includes anomalous data and a category of the anomalous data from the plurality of categories; automatically selecting a data protection action for the anomalous data based on the determined category of the anomalous data; and automatically performing the data protection action. Other aspects include corresponding systems, apparatus, and computer program products for implementation of the corresponding method and its features.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

For a better understanding of the various described implementations, reference should be made to the Description of Implementations below, in conjunction with the following drawings. Like reference numerals refer to corresponding parts throughout the figures and description.

FIG. 1 depicts a block diagram of an example enterprise data security system for intelligently securing anomalous data streams in a computer network, according to aspects of the subject technology.

FIG. 2 depicts an example process flow diagram for training one or more machine learning models to identify anomalous data, according to aspects of the subject technology.

FIG. 3 depicts an example process flow diagram for intelligently securing anomalous data streams in a computer network, according to aspects of the subject technology.

FIG. 4 is a conceptual diagram illustrating an example electronic system for intelligently securing anomalous data streams in a computer network, according to aspects of the subject technology.

### DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

The subject technology addresses the challenge of accurately and efficiently detecting anomalies in large datasets. The system and method described herein utilize a combination of machine learning techniques and LLM reasoning to improve anomaly detection performance and provide valuable insights into the nature of detected anomalies. In this regard, one or more machine learning models are trained to identify anomalous data and to, when identified, determine a type or category of each respective identified anomalous data. The disclosed system monitors, in real time, data streams transmitted through a computer network of an organization and automatically determines, in real time, using the one or more machine learning models, whether the data streams transmitted through the computer network includes anomalous data and, if detected, a type or category of the anomaly. A data protection action is then automatically selected for the anomalous data based on the determined type or category, and the data protection action is performed.

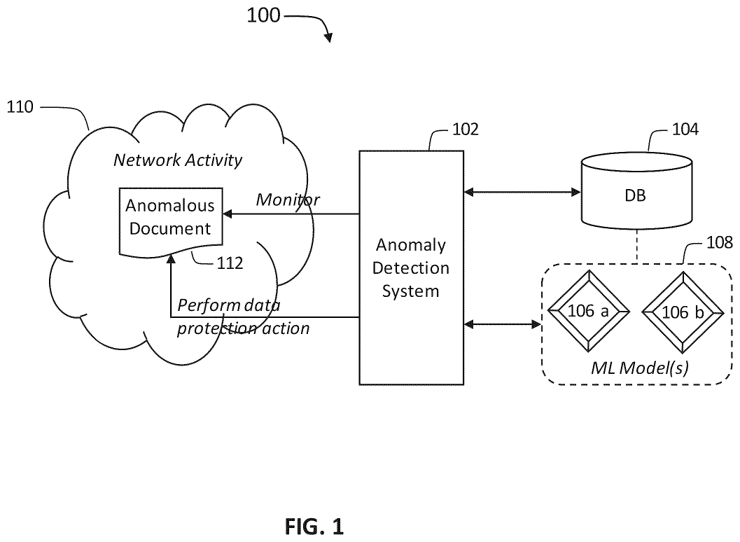

FIG. 1 depicts a block diagram of an example enterprise data security system 100 for intelligently securing anomalous data streams, according to aspects of the subject technology. The disclosed enterprise data security system 100 includes a anomaly detection system 102 for detecting anomalies in data streams, one or more data storage systems 104 and one or more trained machine learning models 106a-b stored in a centralized model storage 108. While these systems and their relevant functions are described separately herein, the functionality of these systems may be incorporated into a single system or server(s) or group of servers. In this regard, the systems may co-exist on the same servers. For example, according to some implementations, multiple machine learning models 106a-b and the data repository of training data may be stored in the same database, cloud storage, local or networked file system and the like.

Data storage systems 104 may include, for example, a centralized database, local or networked file system, model registry, cloud storage, model container, embedded memory, registry, or any other storage system capable of storing large data sets, and/or training data, models, and/or trained models. In connection with training the models of the subject technology, data storage systems 104 may store training data. As will be described further, a training dataset may be created—consisting of documents along with two labels for each document: whether it's an anomaly or not, and if it is, the type of anomaly—and this dataset stored in data storage systems 104. In some implementations, data storage systems 104 may store the training data separate from a trained model 106a-b, which may be stored in centralized model storage 108. Although these storage systems may be separated as depicted, in some implementations, data storage systems 104 may include centralized model storage 108 such as to store one or more of trained models 106a-b.

As depicted in FIG. 1, anomaly detection system 102 monitors a network 110 for anomalies. In this regard, the anomaly detection system 102 may be designed to integrate seamlessly with one or more network and data monitoring systems—including, but not limited to, Intrusion Detection and Prevention Systems (IDPS), Security Information and Event Management (SIEM) systems, Data Loss Prevention (DLP) systems, Endpoint Detection and Response (EDR) solutions, Email Security Gateway (ESG) or Secure Email Gateways (SEG), Advanced Threat Protection (ATP) systems, and Network Traffic Analysis (NTA) platforms—to enhance the detection and analysis of network and data anomalies (including, e.g., email threats). The anomaly detection system 102 may interface with these such, for example, through configurable APIs and adapters, allowing it to ingest and analyze data from a variety of sources such as network packets, logs, document metadata, emails, and file contents. By employing adaptive filtering and multi-layer analysis techniques, the anomaly detection system 102 may identify deviations from baseline behavior across different data points, flagging potential security incidents, such as unauthorized data transfers, malicious document activity, and unusual network patterns. Additionally, the anomaly detection system 102 may support cross-system correlation, enabling it to aggregate insights from multiple monitoring systems, apply context-aware rules, and generate alerts with enhanced accuracy and reduced false positives. The anomaly detection system's 102 architecture may also allow it to operate within various deployment environments, including on-premises, cloud, and hybrid setups, providing a scalable solution that integrates with enterprise security infrastructures to improve real-time anomaly detection and response. These systems can work in combination to provide a comprehensive security solution, detecting a wide range of anomalies and threats across network traffic, data, documents, and endpoints.

In one example, an Email Security Gateway (ESG) may be deployed alongside a SIEM and/or other monitoring systems to ensure that phishing and email-specific anomalies are detected effectively. Integrating the anomaly detection system 102 with an ESG system would provide specialized monitoring for email-based anomalies, enhancing overall threat detection across both network and email communications.

The anomaly detection system 102 monitors data streams transmitted through the network 110. When a data stream 112 (e.g., a document, email or message) is transmitted within the network 110, the anomaly detection system 102 determines, in real time, whether the data stream is anomalous (e.g., includes a document, message or other information that is considered to be an anomaly). As will be described further, this determination may be facilitated by a machine learning model (e.g., 106 a) trained to detect anomalous data in data streams. If anomalous data is detected, the anomaly detection system 102 determines, in real time, a type (or category) of the anomalous data, automatically selects a data protection action for the anomalous data based on the type, and performs the data protection action. The determination of type may also be facilitated by the same or different machine learning model (e.g., model 106b).

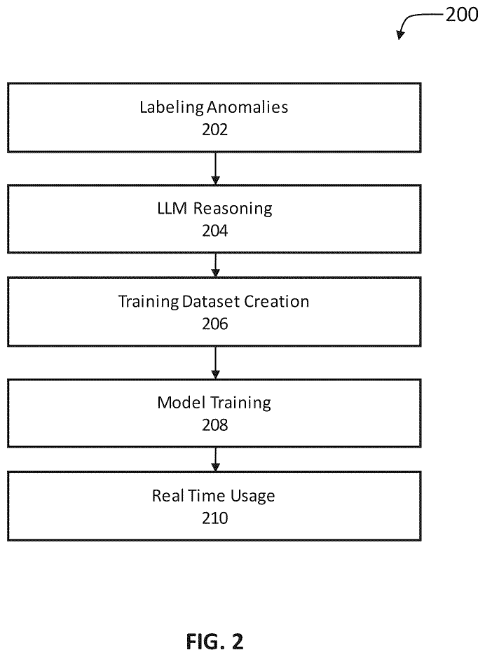

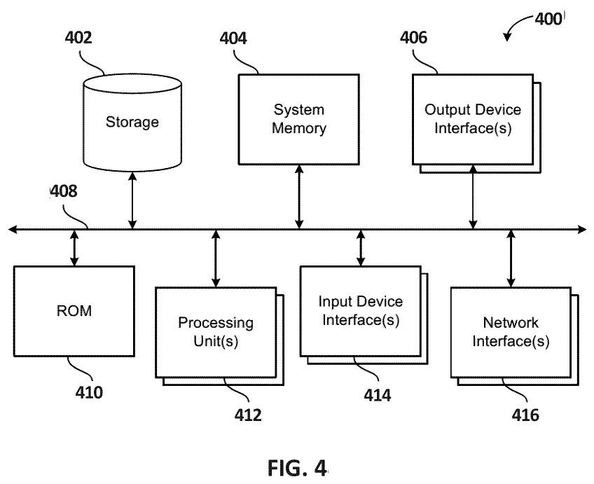

FIG. 2 depicts an example process flow diagram for training one or more machine learning models to identify anomalous data, according to aspects of the subject technology. For explanatory purposes, the various blocks of example process 200 are described herein with reference to FIGS. 1 and 4, and the components and/or processes described herein. One or more of the blocks of process 200 may be implemented, for example, by one or more servers or computing devices, such as a server or other device associated with security anomaly detection system 102. In some implementations, one or more of the blocks may be implemented apart from other blocks, and by one or more different processors (including virtual processors) or devices. Further for explanatory purposes, the blocks of example process 200 are described as occurring in serial, or linearly. However, multiple blocks of example process 200 may occur in parallel. In addition, the blocks of example process 200 need not be performed in the order shown and/or one or more of the blocks of example process 200 need not be performed.

The first stage (202) of the subject technology focuses on identifying and labeling anomalies within a dataset. In some implementations, domain experts can manually review data and identify anomalous instances. This approach is particularly useful for initial dataset creation and for identifying complex anomalies that may be difficult for automated methods to detect.

However, according to various implementations described herein, the subject technology employs a machine learning-based approach. Automated anomaly detection algorithms can be applied to identify potential anomalies. This can involve transforming text data into numerical vectors (e.g., using word embeddings or TF-IDF) and applying anomaly detection algorithms (e.g., One-Class SVM, Isolation Forest).

Smart sampling may be employed to ensure a representative sample of anomalies. This may involve stratified sampling based on data characteristics or focusing on specific data subsets known to contain anomalies. This may be particularly useful when dealing with large datasets where exhaustive labeling is impractical. Domain experts can be leveraged to identify anomalous documents for inclusion in the training data.

Once anomalies are identified, in the second stage (204), an LLM is queried to provide reasoning for the observed anomalies. This stage may be broken down into steps, including the input of data, LLM querying, label generation, and LLM consensus. With regard to data input, both anomalous and non-anomalous documents can be provided as input to the LLM. This allows the LLM to understand the context of the anomaly and provide more nuanced reasoning. The LLM may then be queried to provide an explanation for the identified anomaly. The query can be structured to elicit specific information, such as the nature of the anomaly and its potential impact.

According to various implementations, the LLM may generate two labels as output: (1) anomaly status (e.g., anomalous or not anomalous) and (2) anomaly type (e.g., spam, fraud, system error). These labels can then be stored in a structured format, such as JSON, for easy processing. In some implementations, LLM Consensus may be utilized to improve the reliability of the LLM reasoning. In this regard, multiple LLMs can be queried, and a voting mechanism can be used to determine the final labels. This helps mitigate potential biases or inaccuracies of individual LLMs.

In a third stage (206), a training dataset is created, consisting of documents along with two labels for each document: whether it's an anomaly or not, and if it is, the type of anomaly. The labeled data from the previous stages is used to create a training dataset for the machine learning models. The dataset includes both documents (e.g., original documents, both anomalous and non-anomalous) and labels (e.g., generated by the LLM, including anomaly status and type). The dataset can include a variety of anomalous documents representing different anomaly types to enable multi-category training.

In a fourth stage (208), two models are trained using the dataset. In some implementations, the first model, a text classification model (or Anomaly Status Prediction Model), is used to predict whether a specific document is an anomaly. This can be a binary classification model trained on the labeled documents. The second model, also a classification model (or Anomaly Type Prediction Model), is used to predict the type or category of the anomaly, given that it is indeed an anomaly. This can be a multi-class classification model trained on the labeled documents. Various model architectures can be used, such as deep neural networks or ensemble methods. It is also understood that, in some implementations, a single model may be trained to undertake both of the foregoing functions.

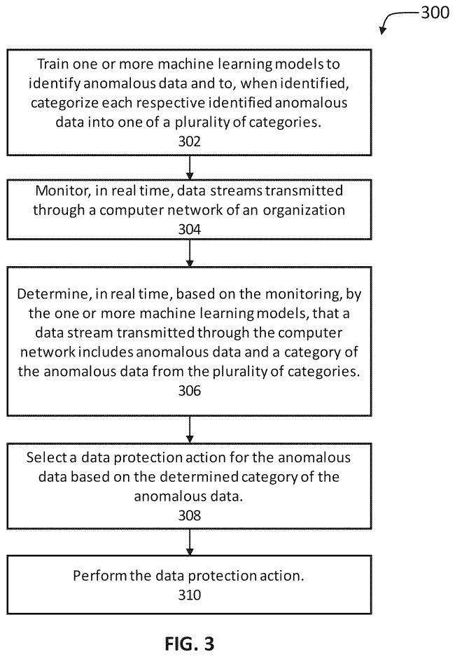

In the depicted fifth stage (210), the trained model(s) are used to predict anomalies and their types in real-time data streams. As will be described further with regard to FIG. 3, new data streams are fed into the trained model(s) (Real-Time Data Input), and the model(s) predict the anomaly status and type for each input document (Anomaly Prediction). In some implementations, for detected anomalies, an LLM can be queried to provide detailed explanations, offering insights into the nature of the anomaly and its potential causes. This information can be used for threat detection, response, and other downstream applications.

FIG. 3 depicts an example process flow diagram for protecting data streams in a computer network, according to aspects of the subject technology. For explanatory purposes, the various blocks of example process 300 are described herein with reference to FIGS. 1, 2, and 4 and the components and/or processes described herein. One or more of the blocks of process 300 may be implemented, for example, by one or more servers or computing devices, such as security manager server(s) 114. In some implementations, one or more of the blocks may be implemented apart from other blocks, and by one or more different processors (including virtual processors) or devices. Further for explanatory purposes, the blocks of example process 300 are described as occurring in serial, or linearly. However, multiple blocks of example process 300 may occur in parallel. In addition, the blocks of example process 300 need not be performed in the order shown and/or one or more of the blocks of example process 300 need not be performed.

In the depicted example, one or more machine learning models are trained to identify anomalous data and to, when identified, categorize each respective identified anomalous data into one of a plurality of categories (or types) of anomalies (302). According to various implementations, as described with respect to FIG. 2, this training may include, for example, providing a plurality of documents to the one or more LLMs. For the purpose of this disclosure a document includes any file, message, email or other structured information capable of being transmitted over a computer network. In this regard, an LLM may be instructed to, for each document, provide a first label indicating whether the document is an anomaly or not and, if the document is anomalous, a second label indicating a type of the anomaly. The first label and second label may be provided by the one or more LLMs in a structured format that is both textually readable and machine parsable. For example, the labels may be provided by the LLMs in a lightweight data-interchange format such as JSON (JavaScript Object Notation). According to various implementations, the first and second labels may be stored in database 104.

In some implementations, the one or more LLMs include a first text classification model for predicting whether each document is an anomaly, and a second text classification model for predicting the type of the anomaly for the document. The first classification model may be trained, for example, to predict whether a new data point is anomalous based on the patterns learned from a labeled dataset, and the second model trained to predict the type of anomaly for data points identified as anomalous. According to various implementations, the categories/anomaly types include, but are not limited to phishing text or email messages, viruses or virus related activity, unauthorized access, data exfiltration, compromised credentials, and malware activity.

As described previously, the training may include providing an anomalous document and other documents that are not anomalous to a large language model (LLM) and asking the LLM why the anomalous document is an anomaly. The LLM, for each document, provides a reason for why the anomalous document is considered anomalous. In some implementations, the LLM is instructed to provide the reasoning merely to help the LLM come to a more accurate conclusion regarding whether the document is anomalous (e.g., to help it think). In some implementations, the reasoning is discarded after being provided and not used further. In some implementations, the reasoning is considered in determining the category of the anomalous document. In some implementations, the reasoning provided by the LLM is not used as further input in the training process. In some implementations, the reasoning is stored for use in connection with the data protection action to be performed.

After the one or more machine learning models are trained, the anomaly detection system 102 monitors (304) data streams transmitted through a computer network 110 of the organization. For example, the system 102 monitors data transmitted within the network 110 (e.g., between nodes and devices) and/or data transmitted between devices and/or nodes within the network 110 and devices and/or nodes external to the network 110. As described with regard to FIG. 2, the anomaly detection system 102 may be designed to integrate with one or more existing network and data monitoring systems such that the one or more machine learning models are associated with and may operate on data obtained by such systems. For example, the one or more machine learning models may be integrated (via system 102) with an email system (e.g., an ESG) to monitor email traffic that passes through the email system. In this regard, data streams may be passed one or more of the machine learning models 106a-b (e.g., to one or more LLMs) in real time for an immediate determination as to whether the data stream includes an anomaly. For example, incoming and outgoing emails may be monitored for unusual content, patterns, or recipients, and the system may inspect email messages and attachments.

In some implementations, the anomaly detection system 102 may monitor user prompts and commands. For example, user interactions with system may be tracked, particularly commands executed on critical servers or applications. The system 102 may also monitor file systems, monitoring when and how customer documents are accessed, modified, or shared. The anomaly detection system may be configured to perform other forms of monitoring, as described further below.

Based on the monitoring, the anomaly detection system 102 automatically determines (306), in real time, (e.g., using the one or more machine learning models) that a data stream transmitted through the computer network 110 includes anomalous data and determines a category of the anomalous data from the plurality of categories. By way of the anomaly detection system 102, the trained models are integrated into the production environment to analyze data streams in real-time. As new data comes in, the anomaly detection model evaluates it to determine if it's anomalous. If anomalous, the classification model identifies the anomaly type. For detected anomalies, the LLMs may generate explanations to provide context.

In this regard, the anomalous data may be provided to one of the LLMs and the LLM asked whether the data is anomalous. In some implementations, if anomalous, the LLM may also return the type/category of the anomaly (e.g., based on its training). In some implementations, the LLM may be instructed to provide a reason for why the anomalous data is considered anomalous, and may return the reason. In some implementations, when the data is identified as anomalous, the anomaly detection system 102 may be configured to generate a notification (e.g., that may be utilized in various reporting applications) indicating the type of anomaly or, in some implementations, the reason for why the anomalous data is considered anomalous.

The anomaly detection system 102 then automatically selects a data protection action (308) for the anomalous data based on the returned determined type/category of the anomalous data, and automatically performs (310) the data protection action. The data protection action performed may be determined based on the type of system integrated with the anomaly detection system 102 (e.g., as discussed with respect to FIG. 2). The selection of the particular data protection action may be based on indexing a lookup table using the type/category of the anomaly, type of data determined to be anomalous, type of system, and/or the like.

According to various implementations, the data protection action may include, for example, issuing an alert, blocking the message, alerting an administrator, quarantining the message, warning a sender of the message, remove or anonymize the sensitive information within the message, sending a notice to a designated individual such as a system administrator, and the like. In some implementations, an alert may provide a description of the data to which the action is applied, as wells as, in some implementations, why the anomalous data is considered anomalous (e.g. the reasoning provided by the LLM). In some implementations, alerts may be sent to a security operations team for immediate review. Users that are involved in the anomalies may be notified, and may provide guidance or training to prevent future occurrences, especially in cases of phishing or social engineering attempts.

Performing the data protection action may include, for example, quarantining the anomalous data and providing an alert pertaining to the anomalous data and the data protection action (e.g., quarantining an email). Performing the data protection action may include blocking the transmitting of the data stream containing the anomalous data and isolating an affected system from the computer network. When the determined category of the anomalous data includes credentials (e.g., user account authorization information, login password and/or username, etc.), performing the data protection action may include disabling an account (e.g., an account associated with the credentials or the user to whom the credentials belong).

As described previously, the anomaly detection system 102 may be configured to detect phishing emails. As an example, an email may be sent to multiple employees requesting them to reset their passwords via an external link. The anomaly detection model flags the email due to unusual content and sender address, and the anomaly classification model labels it as a “Phishing Email.” An example reasoning provided with an alert may indicate “The email contains language urging immediate action to reset passwords and directs users to an unfamiliar URL, which is characteristic of phishing attempts.” A second example may indicate “This email is considered anomalous because it contains language indicative of a phishing attempt, requesting confidential information urgently.” The email is then quarantined, and recipients are prevented from accessing it. An alert can sent to the security team, and potentially affected users are notified.

The anomaly detection system 102 may be configured to identify unauthorized data access. As an example, an employee may access a large volume of confidential documents outside of normal working hours and from an unusual location. The access can be flagged by the anomaly detection model due to deviations in access patterns, and classified as “Unauthorized Access.” An example reasoning provided with an alert may indicate “The user's activity is anomalous because it involves accessing sensitive documents during off-hours from an unrecognized IP address, which may indicate credential compromise.” The user's session may be terminated, and account access restricted pending verification. An alert may be provided to a security team who can investigate the activity to determine if it's malicious.

The anomaly detection system 102 may be configured to prevent data exfiltration. As an example, a process may start transferring data to an external server not whitelisted by the company. The activity is detected by the disclosed models monitoring network traffic patterns, and labeled as a “Data Exfiltration Attempt.” An example reasoning provided with an alert may indicate that “Unusual data transfer is detected to an unapproved external server using an encrypted connection, indicating a possible exfiltration attempt.” The anomaly detection system 102 may block the data transfer and isolate the affected system from the network, and then initiate an investigation to identify the source (e.g., malware, insider threat, etc.).

The anomaly detection system 102 may be configured to detect other enhanced threats. For example, the system may improve detection of sophisticated threats that might bypass traditional security measures by analyzing nuanced patterns in textual data. Real-time detection and automated responses help contain threats quickly, reducing potential damage, while LLM-generated explanations provide clear insights into anomalies, aiding security personnel in making informed decisions. Moreover, automation reduces the reliance on manual monitoring, allowing the system to scale with growing data volumes, and a feedback loop may ensure that the models stay up-to-date with emerging threats and adapt to new attack vectors.

According to various implementations, the anomaly detection system 102 may include a feedback loop whereby feedback from a security team on false positives or newly discovered threats may be used to retrain and update the models. In this regard, the LLM and/or models may be regularly updated with new data to adapt to evolving threat landscapes.

Many of the above-described example steps of process 300, and related features and applications, may also be implemented as software processes that are specified as a set of instructions recorded on a computer readable storage medium (also referred to as computer readable medium), and may be executed automatically (e.g., without user intervention). Any or all of the foregoing steps may be performed by a machine, automatically. That is, the step(s) may be performed without user involvement or action, for example, according to a predetermined programmed schedule or in response to a preceding action. When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

FIG. 4 is a conceptual diagram illustrating an example electronic system for automated data collaboration protection of sensitive content across an enterprise computer network, according to aspects of the subject technology. Electronic system 400 may be a specifically configured computing device for execution of software associated with one or more portions or steps of process 400, or components and processes provided by FIGS. 1 through 3, including but not limited to one or more computing devices implementing the anomaly detection system 102. Such devices may include or be associated with an user endpoint device, internal server, edge device, or external application server. Electronic system 400 may be or include a server, a personal computer or a mobile device such as a smartphone, tablet computer, laptop, PDA, an augmented reality device, a wearable such as a watch or band or glasses, or combination thereof, or other touch screen or television with one or more processors embedded therein or coupled thereto, or any other sort of computer-related electronic device having network connectivity.

Electronic system 400 may include various types of computer readable media and interfaces for various other types of computer readable media. In the depicted example, electronic system 400 includes a bus 408, processing unit(s) 412, a system memory 404, a read-only memory (ROM) 410, a permanent storage device 402, an input device interface 414, an output device interface 406, and one or more network interfaces 416. In some implementations, electronic system 400 may include or be integrated with other computing devices or circuitry for operation of the various components and processes previously described.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process, in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such as a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, e.g., alphanumeric keyboards and pointing devices (also called “cursor control devices”). Output device interfaces 406 enables, e.g., the display of images generated by the electronic system 400. Output devices used with output device interface 406 include, e.g., printers and display devices, such as cathode ray tubes (CRT) or liquid crystal displays (LCD). Some implementations include devices such as a touchscreen that functions as both input and output devices.

Also, as shown in FIG. 4, bus 408 also couples electronic system 400 to a network (not shown) through network interfaces 416. Network interfaces 416 may include, e.g., a wireless access point (e.g., Bluetooth or WiFi) or radio circuitry for connecting to a wireless access point. Network interfaces 416 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 400 can be used in conjunction with the subject disclosure.

Each network connections disclosed herein may be a wired or wireless connection, such as by Ethernet, WiFi, BLUETOOTH, an integrated services digital network (ISDN) connection, a digital subscriber line (DSL) modem, or a cable modem. Direct or indirect network connection may be used, including, but not limited to a telephone modem, an MIB system, an RS232 interface, an auxiliary interface, an optical link, an infrared link, a radio frequency link, a microwave link, a personal area network connection, a local area network connection, a cellular link, or a WLANS connection or other wireless connection.

Enterprise devices incorporating aspects of the subject technology may be equipped with a network interface module (NIM), allowing each device to participate as a node in a network. While for purposes of clarity the subject technology will be described as operating in an Ethernet network environment using the Internet Protocol (IP), it is understood that concepts of the subject technology are equally applicable in other network environments, and such environments are intended to be within the scope of the subject technology.

Data to and from the various data sources can be converted into network-compatible data with existing technology, and movement of the information between the appliances and the network can be accomplished by a variety of means. For example, the appliances and network may communicate via automated interaction, manual interaction, or a combination of both automated and manual interaction. Automated interaction may be continuous or intermittent and may occur through direct network connection, or through RS232 links, MIB systems, RF links such as BLUETOOTH, IR links, PANS, LANS, WLANS, digital cable systems, telephone modems or other wired or wireless communication means. The communication means in various aspects may be bidirectional with access to data from as many points of the distributed data sources as possible. Decision-making can occur at a variety of places within the network.

These functions described above can be implemented in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to specifically configured electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

### Illustration of Subject Technology as Clauses

Various examples of aspects of the disclosure are described as numbered clauses (1, 2, 3, etc.) for convenience. These are provided as examples, and do not limit the subject technology.
Identifications of the figures and reference numbers are provided below merely as examples and for illustrative purposes, and the clauses are not limited by those identification.

Clause 1. A machine-implemented method for protecting data streams in a computer network, comprising: training one or more machine learning models to identify anomalous data and to, when identified, categorize each respective identified anomalous data into one of a plurality of categories; monitoring, in real time, data streams transmitted through a computer network of an organization; automatically determining, in real time, based on the monitoring, by the one or more machine learning models, that a data stream transmitted through the computer network includes anomalous data and a category of the anomalous data from the plurality of categories; automatically selecting a data protection action for the anomalous data based on the determined category of the anomalous data; and automatically performing the data protection action.

Clause 2. The machine-implemented method of Clause 1, wherein training the one or more machine learning models comprises: providing an anomalous document and other documents that are not anomalous to a large language model (LLM) and asking the LLM why the anomalous document is an anomaly; and receiving, from the LLM, a reason for why the anomalous document is considered anomalous, wherein the received reason is not used as input in the training of one or more machine learning models.

Clause 3. The machine-implemented method of Clause 2, wherein training the one or more machine learning models comprises: determining a category of the anomalous document based on the received reason for why the anomalous document is considered anomalous.

Clause 4. The machine-implemented method of Clause 2, wherein the received reason is not used in connection with the performing of the data protection action.

Clause 5. The machine-implemented method of any one of Clauses 1-4, wherein determining that the data stream includes anomalous data and the category of the anomalous data comprises: providing the anomalous data to a large language model (LLM) and asking the LLM why the anomalous data is an anomaly; receiving, from the LLM, a reason for why the anomalous data is considered anomalous; and providing, in connection with performing the data protection action, an alert comprising the reason for why the anomalous data is considered anomalous.

Clause 6. The machine-implemented method of any one of Clauses 1-5, wherein the one or more machine learning models comprises one or more large language models (LLMs), and wherein training the one or more machine learning models comprises: providing a plurality of documents to the one or more LLMs; causing the one or more LLMs to generate, for each document of the plurality of documents, a first label indicating whether the document is an anomaly or not and, if the document is anomalous, a second label indicating a type of the anomaly; and storing the first and second labels in a training database.

Clause 7. The machine-implemented method of Clause 6, wherein the one or more LLMs comprise a first text classification model for predicting whether each document is an anomaly, and a second text classification model for predicting the type of the anomaly for the document.

Clause 8. The machine-implemented method of Clause 6 or Clause 7, wherein the first label and second label are provided by the one or more LLMs in a structured format that is both textually readable and machine parsable.

Clause 9. The machine-implemented method of any one of Clauses 1-8, wherein monitoring data streams comprise: associating the one or more machine learning models with an email system to monitor email traffic that passes through the email system, wherein the monitoring data streams comprises monitoring the email traffic and inspecting email messages and attachments.

Clause 10. The machine-implemented method of any one of Clauses 1-9, wherein the plurality of categories comprise the categories of phishing email, unauthorized access, data exfiltration, compromised credentials, and malware activity.

Clause 11. The machine-implemented method of any one of Clauses 1-10, wherein performing the data protection action comprises quarantining the anomalous data and providing an alert pertaining to the anomalous data and the data protection action.

Clause 12. The machine-implemented method of any one of Clauses 1-10, wherein performing the data protection action comprises blocking the transmitting of the data stream containing the anomalous data and isolating an affected system from the computer network.

Clause 13. The machine-implemented method of any one of Clauses 1-9, wherein the determined category of the anomalous data comprises comprised credentials and performing the data protection action comprises disabling an account.

Clause 14. A system, comprising: a server comprising: one or more processors; and a non-transitory memory storing instructions that, when executed by the one or more processors, causes the one or more processors to facilitate performance of the machine-implemented method of any one of Clauses 1-13.

Clause 15. A non-transitory machine readable medium storing instructions thereon that, when executed by a machine, causes the machine to perform the machine-implemented method of any one of Clauses 1-13.

### Further Considerations

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples. A phrase such as an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A machine-implemented method for protecting data streams in a computer network, comprising:
training one or more machine learning models to identify anomalous data and to, when identified, categorize each respective identified anomalous data into one of a plurality of categories;
monitoring, in real time, data streams transmitted through a computer network of an organization;
automatically determining, in real time, based on the monitoring, by the one or more machine learning models, that a data stream transmitted through the computer network includes anomalous data and a category of the anomalous data from the plurality of categories;
automatically selecting a data protection action for the anomalous data based on the determined category of the anomalous data; and
automatically performing the data protection action.

2. The machine-implemented method of claim 1, wherein training the one or more machine learning models comprises:
providing an anomalous document and other documents that are not anomalous to a large language model (LLM) and asking the LLM why the anomalous document is an anomaly; and
receiving, from the LLM, a reason for why the anomalous document is considered anomalous,
wherein the received reason is not used as input in the training of one or more machine learning models.

3. The machine-implemented method of claim 2, wherein training the one or more machine learning models comprises:
determining a category of the anomalous document based on the received reason for why the anomalous document is considered anomalous.

4. The machine-implemented method of claim 2, wherein the received reason is not used in connection with the performing of the data protection action.

5. The machine-implemented method of claim 1, wherein determining that the data stream includes anomalous data and the category of the anomalous data comprises:
providing the anomalous data to a large language model (LLM) and asking the LLM why the anomalous data is an anomaly;
receiving, from the LLM, a reason for why the anomalous data is considered anomalous; and
providing, in connection with performing the data protection action, an alert comprising the reason for why the anomalous data is considered anomalous.

6. The machine-implemented method of claim 1, wherein the one or more machine learning models comprises one or more large language models (LLMs), and wherein training the one or more machine learning models comprises:
providing a plurality of documents to the one or more LLMs;
causing the one or more LLMs to generate, for each document of the plurality of documents, a first label indicating whether the document is an anomaly or not and, if the document is anomalous, a second label indicating a type of the anomaly; and
storing the first and second labels in a training database.

7. The machine-implemented method of claim 6, wherein the one or more LLMs comprise a first text classification model for predicting whether each document is an anomaly, and a second text classification model for predicting the type of the anomaly for the document.

8. The machine-implemented method of claim 6, wherein the first label and second label are provided by the one or more LLMs in a structured format that is both textually readable and machine parsable.

9. The machine-implemented method of claim 1, wherein monitoring data streams comprise:
associating the one or more machine learning models with an email system to monitor email traffic that passes through the email system,
wherein the monitoring data streams comprises monitoring the email traffic and inspecting email messages and attachments.

10. The machine-implemented method of claim 1, wherein the plurality of categories comprise the categories of phishing email, unauthorized access, data exfiltration, compromised credentials, and malware activity.

11. The machine-implemented method of claim 1, wherein performing the data protection action comprises quarantining the anomalous data and providing an alert pertaining to the anomalous data and the data protection action.

12. The machine-implemented method of claim 1, wherein performing the data protection action comprises blocking the transmitting of the data stream containing the anomalous data and isolating an affected system from the computer network.

13. The machine-implemented method of claim 1, wherein the determined category of the anomalous data comprises comprised credentials and performing the data protection action comprises disabling an account.

14. A system, comprising:
a server comprising:
one or more processors; and
a non-transitory memory storing instructions that, when executed by the one or more processors, causes the one or more processors to facilitate performance of the machine-implemented method of claim 1.

15. A non-transitory machine readable medium storing instructions thereon that, when executed by a machine, causes the machine to perform the machine-implemented method of claim 1.
